(19) United States
(12) Patent Application Publication
(10) Pub. No.: US 2011/0145570 A1
(43) Pub. Date: Jun. 16, 2011

(54) Certified Abstracted and Anonymous User Profiles For Restricted Network Site Access and Statistical Social Surveys

(75) Inventors: Carmi David Gressel, Mobile Post Negev (IL); Gabried Vago, London (GB); Ran Granot, Yavne (IL); Mika Weinstein-Lustig, London (GB); Uzi Apple, London (GB); Herve Amsili, London (GB); Timothy James Salmon, Hertfordshire (GB); Avi Hecht, London (GB); Tomer Kanza, London (GB); Anat Vago, London (GB); Mordechay Hadad, Beer Sheva (IL); Amir Ingher, Beer Sheva (IL)

(73) Assignee: Fortress Gb Ltd., Greater London (GB)

(21) Appl. No.: 11/587,076

(22) PCT Filed: Apr. 21, 2005
(86) PCT No.: PCT/IL05/00432

§ 371 Date: Aug. 15, 2007

Related U.S. Application Data
(60) Provisional application No. 60/565,392, filed on Apr. 22, 2004.

(51) Int. Cl. H04L 9/00

(52) U.S. Cl. 713/159

(57) ABSTRACT

An arrangement, system, and methods for creating and distributing authenticated personal information for users of network services and participants in social surveys, and in chat rooms and other forums. A trusted organization verifies that personal information presented by a user is correct, and authenticates the information in an encapsulated form as “certified profiles” within a smart card or other secure portable hardware device issued to the user Certified profiles are authenticated by digital signatures of the trusted organization and the profile users. Personal information in certified profiles can be in raw and/or in statistically-processed and abstracted form, and can be tailored by the user for specific needs to include whatever personal information is required, and to exclude all other personal information. By the use of unique aliases, it is possible for users to anonymously access restricted network sites and participate in surveys, while still satisfying recipients that supplied personal information is accurate, and for surveys that the user has not responded to the same survey more than once. Users enroll for certified profiles via trusted enrollment vendors who market the service to the public and also make hardware and software available to users for managing, maintaining, and distributing the certified profiles.

### FIELD OF THE INVENTION

The present invention relates to user authentication and certification, and, more particularly, to an arrangement, method, and system for authenticating and validating abstracted and anonymous user personal information for qualifying a user to access restricted network sites, such as chat rooms and the like, and for use in statistical social surveys.

### BACKGROUND OF THE INVENTION

There are various situations encountered in using a wide-area computer network, such as the Internet, where a user may wish, or may be required, to furnish some personal information. For example, a user may wish to participate in a closed chat room, news group, weblog, or social interaction forum that permits only screened individuals to participate, where those who wish to join must first demonstrate eligibility according to certain criteria related to their personal information. For example, a dating service may wish to screen participants according to age, location of residence, education, religion, and stipulate restriction on marital status (e.g., only single, divorced, or widowed individuals). As another example, a user may wish to visit an adult website or qualify for a senior citizen discount on a purchase and must prove only that he or she is above a specified age. As yet another example, a user may volunteer to participate in a social survey, and may need to supply verifiable personal statistical information (age, educational level, income range, political affiliation, etc.) as part of the survey. The terms “restricted network site”, “network site”, and “site” herein denote without limitation any network or broadcast communication arrangement such as a chat room, news group, weblog, social interaction forum, or other similar facility with access limited to a restricted segment of the public. Moreover, in certain situations, a user may wish to participate anonymously, but must still be able to furnish authenticated personal information. For example, a user may wish to visit an adult site without divulging his or her actual identity, but may still be required to prove that he or she is of a proper age to access the site. Although prior art systems have means by which parents can prevent their children from accessing certain sites, it would be more convenient and effective if the system were able to determine by itself what access a particular user has to various material, based on personal information that the user supplies. With respect to this possibility, it would be useful if parents also had access to means for enabling their children to be able to furnish authenticated personal information according to parental pre-screening.

It is desirable to control individual electronic media access in a variety of venues. Besides computer networks, such as the Internet, there are cable and satellite television links controlled by set-top boxes and the like. Thus, the situation is similar for accessing a variety of electronic information media. A cable or satellite television channel, for example, may wish to restrict access to adult programming and adult product purchases to persons who can establish that their age is above a certain minimum. The principles of providing an authenticated user profile also extend to certain uses of a public telephone network.

There are a number of difficulties which users currently encounter when attempting to fulfill the above requirements concerning the supplying of personal information. There are also difficulties that recipients of the information face.

First of all, supplying personal information is usually a very sensitive matter, with potentially serious legal liability on the part of the entity that gathers, receives, handles, or processes such information. The receiver as well as the user have an interest in preventing misuse of the supplied information or unauthorized access thereto.

Second, furnishing personal information on a frequent or repeat basis can be tedious and time-consuming. Currently, many users avoid situations where they have to furnish detailed information, simply because of the effort involved.

Third, receivers of personal information currently have no easy way of validating that the information is accurate. In most cases, they have to depend solely on faith that the user is supplying correct information.

Fourth, in some situations, as noted above, users prefer to participate anonymously, particularly involving adult sites and political or economic surveys. Currently, in many cases, remaining anonymous unfortunately results in bypassing advantageous opportunities. For example, many marketing programs and sales campaigns currently offer loyalty incentives for participation (air miles, “points,” discounts, free membership or services, etc.), and users who wish to remain anonymous currently cannot participate in such programs. This is particularly applicable in the case of surveys, some of which offer meaningful incentives and bonuses to users for their participation. For example, as a benefit for participating in a marketing survey, users might receive a certain amount of time in free Internet or long-distance telephone service; or users might receive time-sensitive information via direct mail from approved vendors who could send them valuable information tailored to their interests. One of the problems with anonymous participation from the standpoint of conducting surveys, however, is that those who conduct the surveys need to be sure that the same user does not participate multiple times in the same survey under different pseudonyms or aliases, because this can erroneously skew the results of the survey. It is further noted that, even in the case where users can remain anonymous, they may still wish to restrict the amount and type of information they provide and the circumstances under which the information will be provided.

Different types of personal information are generally required for different types of activity. For example, to access an adult site, a user may be required only to substantiate that his or her age is above a certain minimum, and possibly to disclose a means of guaranteed payment. For other special-interest sites, a user might have to disclose his or her political affiliation, religion, or other social associating factors.

In general, only a subset or an abstract of a subset of personal information is needed. Even in cases that require precise user identification, such as applying for a loan or mortgage over the network, the user need only supply a subset of personal information. Some personal information, such as race or national origin, can be specifically prohibited by law from being considered for such purposes. In all cases, the user should have maximum freedom in determining what information is to be divulged.

Furthermore, as previously noted, many users would also like to be able to restrict the personal information their minor children are capable of divulging over the network, while still permitting them to access network sites that are appropriate and safe.

In all of these situations, the user should be able to control the personal information divulged, while the receiver should be able to easily validate that the information provided is accurate. Those conducting surveys should also be able to easily validate that any given user has responded to the survey only once, even if that user cannot be individually identified. Furthermore, in some cases, information need not be highly personalized to be useful. In a specialized statistical survey, for example, it may be sufficient to know an individual's income percentile within the general population, rather than the individual's specific income.

There is thus a widely recognized need for, and it would be highly advantageous to have, an arrangement, method, and system that allows network users to acquire various authenticated certificates that convey different subsets of personal information, including certified personal information abstracts which do not reveal their identity. Furthermore, it would be highly desirable for an authorized recipient to be able to easily validate the authenticity of such certified personal information, and, moreover, that the information supplied was actually furnished by the individuals in question. These goals are met by the present invention.

### REFERENCES

Oikarinen, J. and R. Darren, “RFC 1459 Internet Relay Chat”, Innovative Logic Corp., www.invologic.com, May 1993.

Converse, D., et al., “The Open Profiling Standard (OPS)”, Netscape Communications, Verisign Inc., and Firefly Network Inc., http://developer.netscape.com, Jun. 2, 1997.

### SUMMARY OF THE INVENTION

The present invention is of an arrangement, method, and system for providing authenticated certificates that convey specified personal information, or subsets of personal information, in the form of a profile. The term “profile” herein denotes any such subset of a user's personal information. A certifying authority authenticates the profiles using well-known public key encryption methods, and thereby provides a ready means for receivers to validate the profiles and thus establish the dependability of the information contained therein. In addition, embodiments of the present method also make it possible to validate that the information was supplied by the individual whose personal information is represented by the profile. Users can decide what personal information is to be included in a particular profile, and can acquire a number of different profiles for different purposes. For some profiles, the personal information contained therein is statistically abstracted, further increasing anonymity of the user, while still providing valuable information for those who have a need to know.

Having a compliant profile enables a user to access network sites restricted to those with specific qualifications attested to by the profile, and to participate in surveys that are likewise restricted. At the same time, the profile divulges only the information necessary to establish the desired qualification. In particular, it may be possible to divulge sufficient information to establish qualification without divulging the user's identity.

Embodiments of the present invention facilitate the conducting of surveys, by encouraging respondents to participate actively. Allowing a respondent to participate in a survey anonymously enhances the natural social tendency (at least in some societies) to express personal opinions and to speak about one's self. Embodiments of the present invention reward participation by awarding merchant points (such as “air miles”) to respondents for their participation. According to an embodiment of the present invention, the more questions a respondent answers, the more points he or she receives.

Furthermore, in an embodiment of the present invention, a user can choose to have a trusted profiler furnish credit references and other references based on knowledge of his or her personal profile.

The present invention includes methods and procedures for issuing authenticated profiles, allowing the user to easily update his or her personal information and obtain specialized profiles for particular purposes.

Embodiments of the present invention allow a user to safely identify himself or herself with a suitable profile for accessing restricted network sites. With such profiles, a user can choose to participate anonymously in a variety of network forums, while nevertheless satisfying certain requirements based on personal information. A user can release a certified profile along with responses to commercial, political, and social surveys, in a manner which may afford the user various benefits. The present invention encourages the furnishing of personal information on a “need to know” basis, limiting the information divulged to what is really essential for the purposes at hand, and ensuring whatever degree of anonymity the user requires consistent with a legitimate need for the personal information.

Because surveys, forums, chat rooms, and the like, are conducted over public networks and broadcast media as well as over telephone lines, embodiments of the present invention maintain confidentiality and optional anonymity through the use of secure hardware and software, and well-known cryptographic methods. The use of anonymous profiles enhances present survey strategies, by encouraging users to participate in surveys. For a survey, a user answers the questions of the survey and then submits the completed survey along with an relevant profile. For an anonymous profile, although the precise identity of the user is not divulged, the use of a unique alias allows the recipient to detect multiple interactions with the same individual. This allows multiple surveys to overlap one another in certain areas, permitting cross-correlation among themselves to determine consistency of the users' responses.

The present invention facilitates effective and responsible profiling and operation of restricted network sites, by providing inexpensive hardware extensions to computers, set-top box controllers, and mobile phones for offering confidential profiling services that are controlled by the user and the profile provider.

Embodiments of the present invention afford the user the option of verifying profile contents via a plaintext copy thereof prior to forwarding a profile. To insure the integrity of the certified profiles, however, the user cannot alter authenticated profiles.

In an embodiment of the present invention, the user obtains a certified enrollment profile from a certifying authority via a trusted third party. After having obtained an enrollment profile, the user is then able to update his or her profile directly with the certifying authority over the Internet, as well as to obtain additional profiles for specialized purposes. In addition, a user is also able to enroll his or her own minor children with their own profiles, and to supervise the content and applicability of their profiles.

It will be appreciated that a system according to the present invention may be a suitably-programmed computer, and that a method of the present invention may be performed by a suitably-programmed computer. Thus, the invention contemplates a computer program that is readable by a computer for emulating or effecting a system of the invention, or any part thereof, or for executing a method of the invention, or any part thereof. The term “computer program” herein denotes any collection of machine-readable codes, and/or instructions, and/or data residing in a machine-readable memory or in machine-readable storage, and executable by a machine for emulating or effecting a system of the invention or any part thereof, or for performing a method of the invention or any part thereof.

Therefore, according to the present invention there is provided a data device having a certified profile data structure corresponding to a user, the data device containing a public key and a private key belong to the user, the certified profile data structure including: (a) personal information about the user; and (b) the public key; (c) wherein the certified profile data structure is signed by a private key belonging to a trusted certification entity.

In addition, according to the present invention there is provided a method for obtaining a certified profile by a user from a trusted certification entity having a certifying public key and a certifying private key, the method including: (a) enrolling the user with an enrollment vendor authorized by the trusted certification entity; (b) having the user provide personal information to the enrollment vendor; (c) having the enrollment vendor verify the accuracy of the personal information; (d) having the enrollment vendor transmit securely the personal information to the trusted certification entity; (e) having the trusted certification entity create the certified profile, the certified profile containing the personal information signed by the certifying private key; and (f) delivering the certified profile to the user.

### BRIEF DESCRIPTION OF THE DRAWINGS

The invention is herein described, by way of example only, with reference to the accompanying drawings, wherein:

FIG. 1 is a conceptual map of an application space for the present invention, centered around wide-area communications, and including users, trusted profilers, enrollment vendors, survey clients, and restricted network sites.

FIG. 2 illustrates the composition and packaging of a certified profile according to embodiments of the present invention.

FIG. 3 illustrates non-limiting exemplary profiles: a user enrollment profile registered by an enrollment vendor; the confidential database user profile on file in the trusted profiler's secure archive; and several abstracted profiles for the user to employ.

FIG. 4 illustrates the elements and steps of an enrollment method according to an embodiment of the present invention.

FIG. 5 illustrates a hardware configuration according to an embodiment of the present invention for: secure presentation of a certified user profile; for updating profile information; and for obtaining additional profiles.

### DETAILED DESCRIPTION OF THE PREFERRED EMBODIMENTS

The principles and operation of a system and arrangement for an arrangement, method, and system for authenticating and validating abstracted and anonymous user profiles for accessing restricted network sites according to the present invention may be understood with reference to the drawings and the accompanying description.

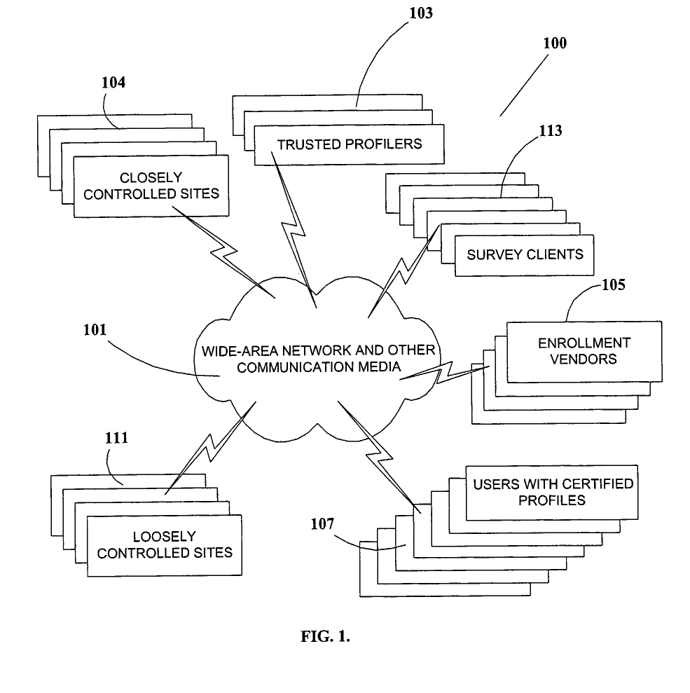

FIG. 1 illustrates an application space 100 of the present invention, centered around wide-area communication network and media 101, linked to which are trusted profilers 103, enrollment vendors 105, users with certified profiles 107 according to the present invention, closely-controlled network sites 104, loosely-controlled network sites 111, and survey clients 113.

Trusted Profiler

In order to create certified (or “authenticated”) profiles that can easily be validated, the present invention provides for a profile certifying authority that is trusted by outside parties to ascertain that a given profile accurately presents personal information about the particular user to whom the profile has been assigned. The term “trusted profiler” herein denotes such a certifying authority.

A trusted profiler has a secure and certifiable public key, and confidentially and securely archives and processes personal information attributes of users. The certifying of a key is well-known in the art, and can involve a hierarchy of certificates that can be traced to a high-level, widely-trusted certifying authority. The trusted profiler certifies, with a high degree of public trust, that profiles containing such attributes reflect the personal attributes of the individuals to which they are assigned. The authentication of the profiles is done by the trusted profiler according to public-key cryptographic techniques that are well-known in the art, in such a manner that the certification by the trusted profiler can easily be validated by anyone with access to the trusted profiler's public key, but also in a manner that prevents alteration and forgery of the profiles. These factors allow other organizations and entities which have faith in the integrity of the trusted profiler, to obtain accurate personal information from users without having to conduct their own verification procedures. Based on this information, users can obtain access to restricted network sites and participate in surveys requiring a high degree of confidence.

The trusted profiler will typically have a reasonably complete listing of user personal information, maintained in a secure and confidential manner. The user may request the trusted profiler to certify a specified subset (or “abstract”) of this information about himself or herself, such that the subset qualifies the user for: access to restricted network sites (e.g., professional, recreational, political, or religious sites, such as chat groups, weblogs, and the like); or qualifies the user to vote or express an opinion in social surveys. As will also be discussed further, in embodiments of the present invention, the trusted profiler may also statistically process personal information the user has furnished.

Certified Profiles and Their Employment

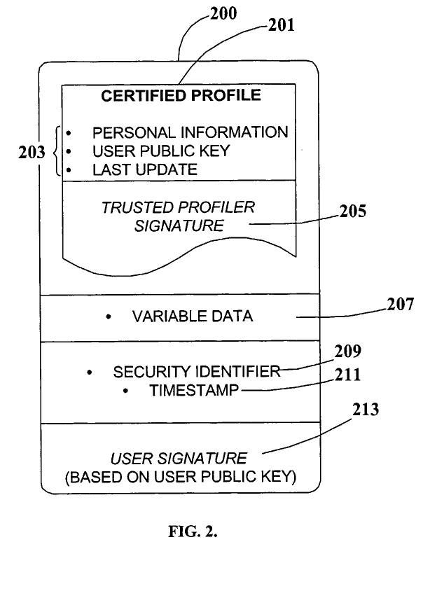

FIG. 2 illustrates a data package 200 sent by a user to a receiver, containing a certified profile 201. As non-limiting examples, data package 200 could be a request for access to a restricted network site or a response to a survey. Certified profile 201 contains an information grouping 203, which includes: personal information about the user; a public key belonging to the user; and a timestamp of the last update of the personal information by the user with the trusted profiler. Certified profile 201 is signed by the trusted profiler with a digital signature 205. Digital signature 205 can be created using any of a number of well-known protocols and methods. As a non-limiting example, digital signature 205 can be the signature of a secure hash of information grouping 203, allowing information grouping 203 to be left in plaintext form for easy reading and use. As another non-limiting example, digital signature 205 can be implemented as a digital envelope, where information grouping 203 is encrypted with a key that is signed by the trusted profiler. Regardless of how the signature is applied, the result is that certified profile 201 can be easily ascertained, via the public key of the trusted profiler, that certified profile 201 is authentic and has not been altered or forged. Thus, the personal information in certified profile 201 can easily be validated.

Data package 200 may contain optional variable data 207, which can include, but is not limited to: a request for access to a restricted network site; or the responses to a survey. In an embodiment of the present invention, data package 200 includes a security identifier 209, which typically prevents reuse or unauthorized use of data package 200. As is well-known in the art, a non-limiting example of a security identifier is a unique (often random) number or string previously generated by the intended recipient and sent by the recipient to the user for this specific transmission of a data package. For instance, a survey questionnaire to the user may include such a unique number or string, which the user must include with his or her response to the survey. In addition, data package 200 may also include an optional timestamp 211. Finally, data package 200 is signed with a digital signature 213 by the user with the user's private key, corresponding to user public key in information grouping 203. It is noted that, depending on the cryptosystem employed, different public keys can correspond to a common private key. In cases where several distinct public keys are assigned to a user to allow that user to participate anonymously in different activities, in a preferred embodiment of the present invention, the distinct public keys are chosen in such a way that each distinct public key corresponds to a distinct private key.

As with trusted profiler digital signature 205, user digital signature 213 can be applied in a number of ways, as is well-known in the art. The recipient can thus validate data package 200 in the following ways: as having come from the intended user (by matching the user's public key in information grouping 203 with the key needed to validate the user digital signature 213); as being in response to the recipient's request (by comparing the signed security identifier 209); and as having valid personal information about the user (by validating certified profile 201 with the trusted profiler's public key).

Profiles and Information Contained Therein

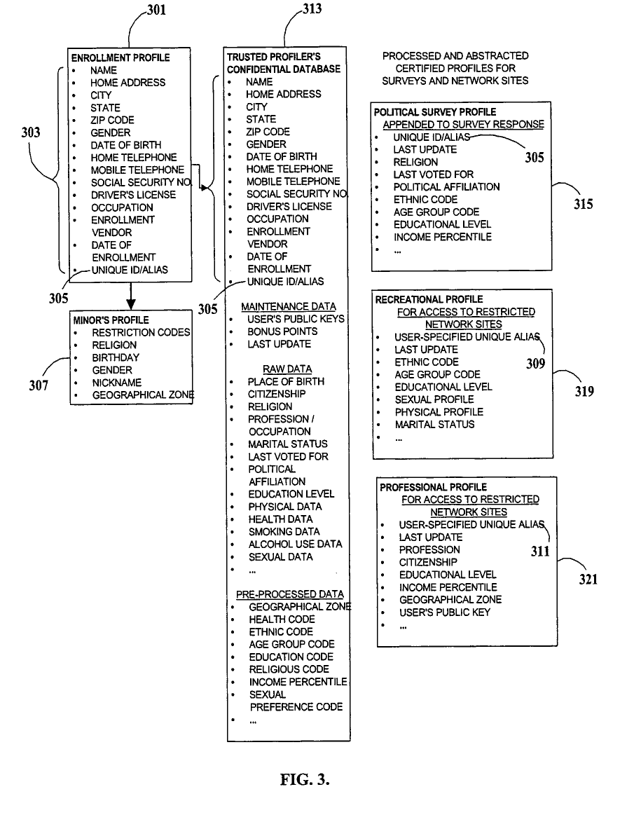

FIG. 3 illustrates various profiles according to embodiments of the present invention, starting with an enrollment profile 301, which is prepared by the user on the premises of an enrollment vendor, as detailed below. Enrollment profile 301 contains basic personal information 303 about the user, which is verified by the enrollment vendor, also as detailed below. Included in basic personal information 303 is at least one unique ID/alias for the user which is assigned during enrollment and which cannot be changed. With this unique ID/alias, the user can participate anonymously in surveys (for example), but the fact that this unique ID/alias cannot be changed precludes the possibility of participating anonymously under a different alias. The survey can stipulate that if the user wishes to participate anonymously, he or she may do so only via the non-changeable enrollment ID/alias. This is illustrated for a political survey profile 315. In a similar manner, other restricted sites may also make this a condition for anonymous access. In contrast, however, according to an embodiment of the present invention, the user may request from the trusted profiler, and be issued thereby, changeable aliases, such as a unique user-specified alias 309 for access to a restricted recreational site, or a different unique user-specified alias 311 for access to a restricted professional site. Using a variety of aliases allows a user to participate anonymously in a variety of different areas in such a way that such participations cannot be correlated by third parties, even in collusion with one another. As a non-limiting example, a recreational profile 319 identifies the user with user-specified alias 309, whereas a professional profile 321 identifies the same user with a different user-specified alias 311. Thus, it is not possible for an outsider to determine that the user who accesses a restricted recreational site with profile 319 is in fact the same individual who accesses a restricted professional site with profile 321. Moreover, the user can select statistically-processed personal information for inclusion in a certified profile, further increasing the anonymity of the certified profile without reducing the utility of the profile for legitimate purposes.

According to an embodiment of the present invention, the user can also obtain a profile 307 for a minor child. Such a profile has minimal personal information content, consistent with the need to allow children safe access to appropriate network sites.

Site Control

Not all restricted network sites require the same degree of control. According to an embodiment of the present invention, restricted sites can be classified as “closely-controlled” or “loosely-controlled” depending upon the degree of restriction desired.

Closely-Controlled Sites

The trusted profiler receives a request to join closely-controlled site, identifies the user, for that site, and certifies each registration of a user to the site. The administrator of the closely-controlled site, upon receipt of the certificate and the request from the user, invites the user to the site and links thereto, and may ascertain, at reasonable intervals, whether the user is linked to the site, and if so, reports to the trusted profiler attributes of the connection.

Loosely-Controlled Sites

In a loosely-controlled site the owner/operator permits a previously-identified and profiled authorized user to participate in an area of the site that corresponds to the user's request and profile. In a non-limiting example, a user seeking to pose a professional problem to a closed group would be connected by the group and identified only by an alias, such as user-specified unique ID/alias 311; in contrast, a user wishing to chat with a political forum on television might be identified only by a limited profile, perhaps having no personal identification at all.

Surveys

The inclusion of certified personal information with the response to a survey prevents misleading responses to the survey. Without such protection, a user might deliberately misrepresent his or her personal information with the intention of falsely skewing the survey.

In an embodiment of the present invention, a survey organization would request a trusted profiler to randomly sample the user base according to some parameters. As a non-limiting example, a survey organization requests a trusted profiler to randomly select 5,000 users within a certain age range, within a certain annual income percentile, and who have a certain educational level. Then the trusted profiler sends the survey to each of the randomly-selected users. Each user receives not only the survey questions, but also a copy of their personal profile for examination. Preferably, the profile does not identify the user individually, but only statistically, as previously discussed. In an embodiment of the present invention, a user may delete information from his or her profile, but may not make other alterations. In another embodiment of the present invention, a user may not make any changes at all. Preferably, the copy of the personal profile would be encrypted using the user's public key, so that the user can read the profile, but nobody else would have access thereto. After the user answers the survey questions, the answers and the user's profile would be encrypted using the survey organization's public key, and the number of questions answered would be encrypted using the trusted profiler's public key. These operations are preferably performed by a software application installed on the user's computer. Then, both the encrypted files are sent to the trusted profiler, who decrypts the number of questions answered by the user, thus informing the trusted profile of how many points to award the user, and thus how much to invoice the survey organization. The trusted profiler then sends the encrypted survey to the survey organization, who decrypts the file to learn the answers, along with the (anonymous) profile of the user who answered the questions.

According to an embodiment of the present invention, data supplied for a survey includes the user's profile in digitally-signed plaintext to facilitate comparison of the responses with the user's profile.

In an embodiment of the present invention, answers to some queries of a survey questionnaire are mandatory, whereas other answers are optional. Non-limiting examples of the latter include those relating to religious persuasion, sexual preferences, or other data that users might be reluctant to divulge. To conform with this option, the user can obtain a profile which does not include such personal information that he or she does not wish to divulge.

In an embodiment of the present invention, a trusted profiler and a survey service can work together to distribute surveys to randomly selected users with a predetermined statistical distribution. For example, to anticipate the results of an election, a survey could poll an equal number of users from each income percentile, randomly chosen from the percentile group, and in addition, supply the survey client with the statistical distribution of polled users by religion and previous political preference.

In an embodiment of the present invention, the trusted profiler would itself serve as a survey organization, capable of assembling a statistical report of aggregated personal information on file.

Enhancing Anonymity by Statistical Processing of Personal Information

In an embodiment of the present invention, a trusted profiler enhances anonymity by converting telltale personal information into statistically-processed data. For example, a user's exact income, is converted to a percentile; weight and height is likewise converted to a body mass percentile; and so forth.

Such statistical grouping also simplifies and facilitates carrying out surveys, lowers the cost to the survey client, and enhances the scope and accuracy of data, for automated processing of statistical information.

FIG. 3 illustrates some non-limiting statistically-relevant items that would be found in the personal profile of an ordinary citizen. Although relatively few individuals would normally consent to divulge all the information illustrated in FIG. 3, many people would permit anonymous abstracted subsets of this information.

Methods for Obtaining Certified Profiles

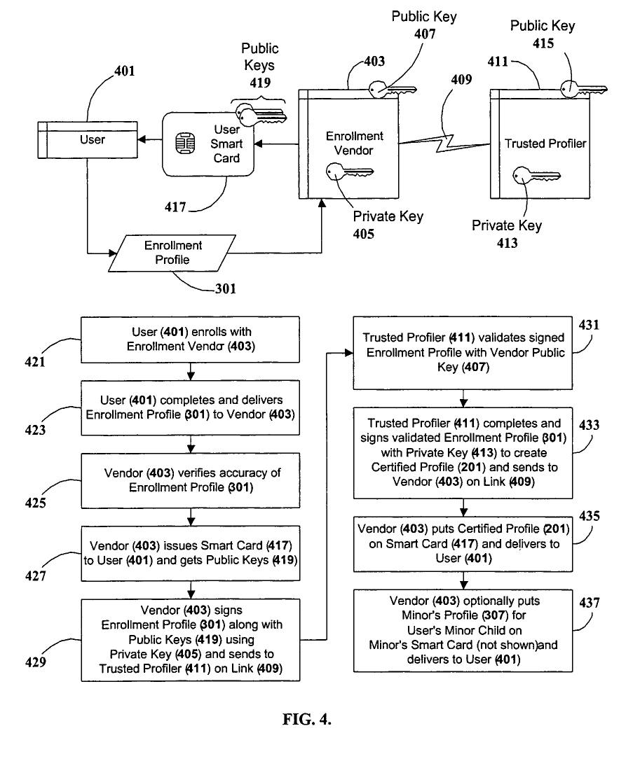

FIG. 4 illustrates the elements and steps of a method of user enrollment according to an embodiment of the present invention. A user 401 who wishes to obtain and use certified profiles for the purposes discussed herein seeks an enrollment vendor 403, who is an agent of a trusted profiler 411 and/or who is authorized thereby. Trusted profiler 411 and enrollment vendor 403 advertise their services to the public, so that prospective users know about them. Enrollment vendor 403, in a non-limiting example, could have a business location in a shopping mall, such as in a kiosk for easy public access. In embodiments of the present invention, enrollment vendors also include, but are not limited to: banks, postal services, telephone service providers, health-care organizations, and the like.

Enrollment vendor 403 is connected to trusted profiler 411 via a link 409, which can, as a non-limiting example, be via the Internet or other wide-area network 101, as illustrated in FIG. 1, where trusted profiler 411 is one of trusted profilers 103 and enrollment vendor 403 is one of enrollment vendors 105. To enable secure and authenticated communications, as is well-known in the art, enrollment vendor 403 has a widely-distributed public key 407 corresponding to a private key 405, and trusted profiler 411 has a widely-distributed public key 415 corresponding to a private key 413.

A typical enrollment method results in the issuing to user 401 of his or her first certified profile based on an enrollment profile 301 (FIG. 3), in a secure device, a non-limiting example of which is a smart card 417. Other non-limiting examples of suitable secure devices include: smart tags; cellular telephones; personal digital appliances (PDA's); and remote control. Reference to FIG. 3 and the previous discussion shows that enrollment profile 301 is a relatively simple profile, which nonetheless is the basic first certified profile that a user obtains. In an embodiment of the present invention, the trusted profiler also includes information concerning the enrollment vendor with whom the user originally enrolled and identification of the trusted profiling officer who accepted responsibility for identifying the user, along with the time and place of enrollment.

A trusted profiler certifies that the user produced conventional identification (including, but not limited to photo identification such as a driver's license, passport, and so forth; credit cards, bank account documents, and the like), and that the user represented himself or herself with regard to residence, employment, and other personal information.

In a step 421 user 401 enrolls with enrollment vendor 403. Enrollment involves establishing a business relationship as a customer of enrollment vendor 403. Examples of aspects of such a relationship include, but are not limited to: and agreeing to abide by certain terms and conditions of using certified profiles; payment of related fees; learning the proper employment of certified profiles, and the benefits thereof; agreeing to represent his or her personal information accurately to enrollment vendor 403 and trusted profiler 411; and agreeing to the secure storage of his or her personal information in confidence by trusted profiler 411, according and subject to applicable laws and regulations.

In a step 423, user 401 completes and delivers enrollment profile 301 to enrollment vendor 403. This is typically done electronically, for example, via a terminal at the facilities of enrollment vendor 403. In a step 425, enrollment vendor 403 verifies enrollment profile 301, as furnished by user 401. This may be done, for example, by having a trusted employee of enrollment vendor 403 compare the information supplied by user 401 with official identification documents presented by user 401, such as a driver's license, passport, or other generally-accepted picture ID. Additional verification can be done by searching telephone listings, and by obtaining a biometric record. In an embodiment of the present invention, enrollment procedures are similar to those disclosed in U.S. Pat. No. 6,311,272 to the present inventor, which is incorporated by reference for all purposes as if fully set forth herein.

In a step 427, enrollment vendor 403 issues a smart card 417 or similar substantially-equivalent portable secure tamper-resistant hardware data storage device to user 401, and gets public keys 419 from smart card 417. The term “intellifier” herein denotes any such secure hardware device which can be used as an “intelligent identifier”. In an embodiment of the present invention, smart card 417 internally generates public/private keypairs as mandated by the trusted profiler, presenting public keys for external use while maintaining private keys internally in such a manner as not to be externally readable. Smart cards and similar devices with such abilities are available commercially. In an embodiment of the present invention, every distinct identification of the user (such as an alias assigned for anonymous access) has a distinct public/private keypair. In this manner, each identifier has a different public key, to prevent associating different identifiers (such as aliases) with the same user by comparing their public keys. As previously detailed, in an embodiment of the present invention, enrollment profile 301 is set up with two distinct identifiers for user 401: one identifier is a legal name of user 401, and the other identifier is unique ID/alias 305 which is neither a legal name of user 401 nor a name by which user 401 is generally known. In this embodiment, therefore, there are two distinct public keys 419, one of which is associated with the legal name of user 401, and which appears in the certified enrollment profile of user 401, in information grouping 203 of certified profile 201 (FIG. 2).

In a step 429, enrollment vendor 403 signs enrollment profile 301 along with public keys 419 using private key 405 and sends signed enrollment profile 301 to trusted profiler 411 on link 409. In a step 431, trusted profiler 411 validates the signed enrollment profile with enrollment vendor public key 407 and validates the trusted enrollment officer. Then, in a step 433 trusted profiler 411 completes and signs the validated enrollment profile with private key 413 to create certified profile 201, and sends the certified profile to enrollment vendor 403 on link 409. Finally, in a step 435, enrollment vendor 403 puts certified profile 201 on smart card 417 and delivers smart card 417 to user 401. User 401 now has a certified identification profile on a secure hardware device, enabling him or her to obtain further certified profiles, as will be detailed in the following section. In an optional step 437, enrollment vendor 403 puts a minor's profile 307 for a minor child of user 401 on a minor's smart card (not shown), which is then given to user 401.

In addition to furnishing the user with a smart card (or similar “intellifier”), the enrollment vendor also markets and sells devices and software by which the user can interface the smart card with a personal computer for connecting with the trusted profiler, in order to obtain additional certified profiles and to use certified profiles to access restricted sites and participate in surveys.

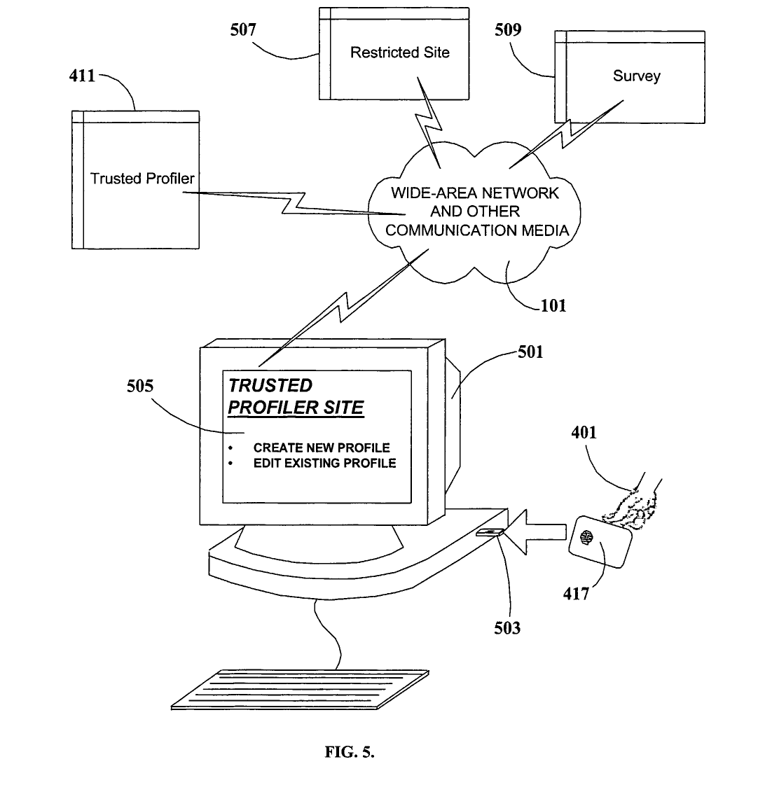

FIG. 5 illustrates a configuration whereby user 401 employs smart card 417 by insertion thereof into an interfacing device 503 in a personal computer 501. In an embodiment of the present invention, device 503 and similar devices can be obtained by purchase from enrollment vendor 403. In FIG. 5, user 401 has connected via wide-area network 101 to trusted profiler 411, and is viewing a page 505 from the site of trusted profiler 411. Because user 401 already has obtained a certified enrollment profile according to the method detailed above, he or she is able to deliver additional personal information to trusted profiler and/or obtain further specialized certified profiles from trusted profiler 411 via this on-line connection, and to modify existing certified profiles. User 401 is authenticated through smart card 417, which can involve password verification and other techniques as are well-known in the art. Personal information is uploaded securely, and new and modified certified profiles are downloaded securely and stored in smart card 417 through secure point-to-point protocols, as are also well-known in the art. In a similar manner, user 401 is able to connect to a restricted network site 507 or a survey 509 via network 101, and upload certified profiles from smart card 417. Through the employment of such certified profiles, user 401 can gain access to restricted site 507 and participate in survey 509. It is noted that smart card 417 (or similar secure “intellifier”) is resistant to tampering through means that are well-known in the art, and that, consequently, recipients of certified profiles have a high degree of confidence that the received certified profiles accurately represent the personal information of user 401.

In an embodiment of the present invention, smart card 417 also contains financial functions and a purse to enable the user to employ smart card 417 interactively make purchases of goods and services. Smart card 417 can also contain a purse to accumulate bonus points and other loyalty incentives for participating in surveys.

Additional personal information furnished to the trusted profiler by the user includes, but is not limited to: banking and financial data; telephone numbers; driver's license data; insurance information; home ownership; and professional certifications. In cases where such information must be verified through examination of documents, the user may be required to physically visit the premises of an enrollment vendor to have this information authenticated.

Archiving and Maintaining of Profiles

In an embodiment of the present invention, only the trusted profiler maintains an archive of user personal information. Typically, the trusted profiler abstracts and releases personal information to the users on a regular basis, in order that they update and certify that the information is correct. In an embodiment of the present invention, the user always has the option of reviewing, correcting, and deleting certified profiles.

While the invention has been described with respect to a limited number of embodiments, it will be appreciated that many variations, modifications and other applications of the invention may be made.

1-11. (canceled)

12. A system enabling users to divulge personal information on a “need to know” basis, the system comprising:
an enrollment vendor operative to generate an enrollment profile for each user in a population of users;
a plurality of portable devices issued by said enrollment vendor to a corresponding plurality of certified users, including at least one name-based signature functionality based on a name of the user, the plurality of portable devices comprising at least one portable device including at least one alias-based signature functionality based on an alias of the user that differs from the user's name; and
a trusted certification authority which, for each user (a) confidentially maintains a set of personal data therefor; (b) generates, from said set of personal data, at least one profile for the user, each of which profiles comprises only data consistent with the intended use of said profile; and (c) generates certified data packages each containing at least one profile cryptographically signed by the trusted certification authority and by at least one of the user's signature functionalities.

13. A system according to claim 12 wherein said portable devices are selected from a group consisting of smart cards; smart tags; cellular telephones; and portable personal digital appliances.

14. A system according to claim 12 wherein said enrollment vendor and said trusted certification authority maintain on-line computer connections to one another.

15. A system according to claim 12 wherein said at least one profile includes at least one of the following: a profile responsive to a survey; and a profile enabling a user to participate in a network forum.

16. A system according to claim 12 and wherein each said portable device is operative to prove its identity to the trusted certification authority, to receive therefrom a data package containing at least one profile of the individual user, to generate a display of said profile and, upon actuation, to sign said data package and return it to said trusted certification authority.

17. A system according to claim 16 wherein said portable device is also operative, upon actuation, to remove content from said data package before signing it and returning it to said trusted certification authority.

18. The system as in claim 12 wherein the trusted certification authority is operative to generate a random sample of users representing at least a selected portion of the population of users.

19. The system as in claim 12 wherein the trusted certification authority is operative to verify user profiled data.

20. A method enabling users to divulge personal information on a “need to know” basis, the method comprising:
generating an enrollment profile for each user in a population of users, issuing to each certified user at least one portable device including at least one name-based signature functionality based on a name of the user, and issuing to at
least some users, at least one portable device including at least one alias-based signature functionality based on an alias of the user that differs from the user's name;
providing a trusted certification authority which confidentially maintains a set of personal data for each user;
generating, from said set of personal data, at least one profile for the user, each of which profiles comprises only data consistent with the intended use of said profile; and
generating certified data packages each containing at least one profile cryptographically signed by the trusted certification authority and by at least one of the user's signature functionalities.

21. A system according to claim 20 and wherein each said portable device is operative to prove its identity to the trusted certification authority, to receive therefrom a data package containing at least one profile of the individual user, to generate a display of said profile and, upon actuation, to sign said data package and to return it to said trusted certification authority, in cooperation with a non-portable device which is in data communication with said portable device and is superior thereto in at least one of the following: its computational abilities; and its display abilities.
